(19) United States
(12) Patent Application Publication
(10) Pub. No.: US 2013/0066757 A1
(43) Pub. Date: Mar. 14, 2013

(54) SYSTEM AND METHOD FOR IDENTIFYING, LOCATING AND RECOVERING COLLATERALIZED ASSETS

(71) Applicants: Robert R. Lovelace, The Colony, TX (US); Louis Paul LeRoux, II, Loveland, CO (US)

(72) Inventors: Robert R. Lovelace, The Colony, TX (US); Louis Paul LeRoux, II, Loveland, CO (US)

(21) Appl. No.: 13/450,406

(22) Filed: Apr. 18, 2012

Related U.S. Application Data
(60) Provisional application No. 61/532,238, filed on Sep. 8, 2011.

(51) Int. Cl. G06F 17/30; G06Q 20/22

(52) U.S. Cl. 705/35; 707/770; 707/E17.014

(57) ABSTRACT

A system and method for identifying, locating and recovering collateralized assets are provided.

### CROSS REFERENCE TO RELATED APPLICATIONS

This application claims priority to U.S. Provisional Patent Application No. 61/532,238, filed Sep. 8, 2011, which is incorporated herein by reference as if fully set forth herein.

### FIELD OF THE INVENTION

The present invention relates generally to the field of electronic data processing and computerized data bases. More specifically, the present invention relates to an improved system and method for identifying, locating and recovering collateralized assts such as motor vehicles and the like.

### BACKGROUND OF THE INVENTION

When an individual or organization purchases a relatively high priced item such as an automobile, motorcycle, boat, or airplane, the buyer normally does not pay cash for the full purchase price. Typically, a cash down payment is made, and the balance of the purchase price is financed over time. In such financed transactions, the lender will place a lien upon the property, and the property becomes a form of collateral to secure the loan. Should the borrower fail to make the scheduled payments, default on the loan, or otherwise breach the loan agreement, the lender may repossess the property to secure its interest in the transaction and to recover at least a portion of the money that it loaned to the purchaser.

Collateralized asset recovery has become a huge business in the United States. Recent statistical data suggests that in 2010, approximately 1.5 million repossessions occurred, and over 15,000 lending institutions and approximately 5,000 repossession firms are in current operation in the U.S. The process of repossessing collateralized assets can be complex, expensive, inefficient and unpleasant. In many instances, lending institutions and lien holders are not set up to perform the actual search for and physical repossession of the asset. Accordingly, they are required to retain the services of a third party repossession agent or firm, also known by various other names such as skip tracers and so forth, to identify, locate and retake possession of the collateral for the benefit of the lender. The whole process may be made more complicated by an unscrupulous borrower who may hide the asset in an effort to avoid losing possession of its use.

With the advent of modern computer information processing, database and telecommunications technologies (in particular, wireless cellular voice, data and visual image recognition and transmission capabilities), large amounts of information and data which would heretofore have been on paper forms, may be collected, categorized, stored and transmitted instantaneously amongst the various parties involved in the asset recovery process. The information or data needed to complete a routine repossession order would include, by way of example, the borrower's, name, address, telephone number, driver's license and/or social security number, name of employer, vehicle license plate and vehicle identification number (VIN). This information must be provided to a repossession firm in a timely and accurate manner to ensure rapid recovery of the properly identified collateral to minimize the lender's loss which could result from improper disposition or malicious destruction of an asset by the borrower in possession or, alternatively, potential liability which could arise from the inadvertent repossession of an improperly identified asset belonging to another person.

Various prior art systems have been disclosed which attempt to address the foregoing problems in asset identification and recovery and related applications such as in law enforcement operations. For example, U.S. Pat. No. 6,081,206, issued to Kieland on Jun. 27, 2000, discloses a video camera system mounted on a parking enforcement vehicle which records license plate data from vehicles parked in areas governed by posted time limits. The data is stored in a computer and compared with data gathered from the same location using a license plate recognition algorithm after the posted time limit has expired to identify violations of the posted regulations. The system then generates citations on the spot via a printer mounted in the parking enforcement vehicle, which may be placed on the illegally parked automobile. While this system is adapted for use in law enforcement applications, in its published form, it does not provide the capability to be adapted for use by repossession contractors.

US Patent Application Publication No. 2003/0154119 published by Stoliker et al., Aug. 14, 2003, discloses an online method and system for issuing vehicle repossession assignments to vehicle repossession contractors. This system and associated method includes at least one server computer configured to host a secure online account for a repossession contractor. The contractor's field agents may access the assigned account to receive new repossession orders and modifications to existing orders and to input feedback regarding active orders in process, such as a successful completion of a repossession assignment. The system and method of the Stoliker et al. disclosure represents a significant advancement in repossession order processing over prior art systems; however, it does not address the problems associated with the potentially high costs and inefficiencies of having retained repossession agents in the field searching for specific collateralized assets which may or may not be concealed. Nor does it incorporate the technological advances in telecommunications and data processing technology discussed above which may be used to significantly enhance the overall efficiency and profitability of the asset recovery process.

Accordingly, a need has arisen for an efficient and cost-effective system and associated method using up to date video transmission, telecommunications, and optical character recognition and data processing systems for identifying, locating and recovering collateralized assts.

### SUMMARY OF THE INVENTION

It is therefore an object of the present invention to provide an improved system and method for identifying, locating and recovering collateralized assets which overcomes the deficiencies of prior art systems and methods.

In one embodiment, a system and method is provided which provides an individual Internet access to a data base containing information related to repossession orders from subscribers for collateralized assets believed to be located within a geographical area and connects the individual to a representative of the subscriber to initiate recovery procedures, once the individual locates the asset.

In another embodiment, a system and method is provided which enables an individual in the field to utilize cellular telephone data and image transmission technology to communicate from the field directly with a database containing information related to repossession orders to verify whether or not a specific identified asset is the subject of a repossession order and to initiate recovery procedures.

In yet another embodiment, a system and method is provided which enables an automatic license plate recognition camera (“ALPR camera”) to communicate from the field directly with a database containing information related to repossession orders to verify whether or not a specific identified asset is the subject of a repossession order and to initiate recovery procedures.

These and other objects and features of the present invention will be apparent from the accompanying description of the invention, diagrams and supplemental supporting materials provided herein.

### BRIEF DESCRIPTION OF THE DRAWINGS

Referring now to the attached drawings which form a part of this original disclosure:

FIG. 1 is a block diagram of a system for identifying, locating and recovering collateralized assets according to an embodiment of the invention;

FIG. 2 is a schematic diagram of a flowchart illustrating a method for identifying, locating and recovering collateralized assets according to an embodiment of the invention;

FIG. 3 is a schematic diagram of a flowchart illustrating a method for identifying, locating and recovering collateralized assets according to another embodiment of the invention;

FIG. 4 is a schematic diagram of a flowchart illustrating a method for identifying, locating and recovering collateralized assets according to another embodiment of the invention; and

FIG. 5 is a block diagram of a machine in the example form of a computer system within which a set of instructions for causing the machine to perform any one or more of the methodologies discussed herein may be executed or stored.

### DESCRIPTION OF THE INVENTION

It should be noted that the present description is by way of illustration only, and that the concepts and examples presented herein are not limited to use or application with any single system or methodology. Hence, while the details of the system and methods described herein are for the convenience of illustration and explanation with respect to the exemplary embodiments, the principles disclosed may be applied to other types of asset identification, location and recovery systems and methods without departing from the scope of the present invention.

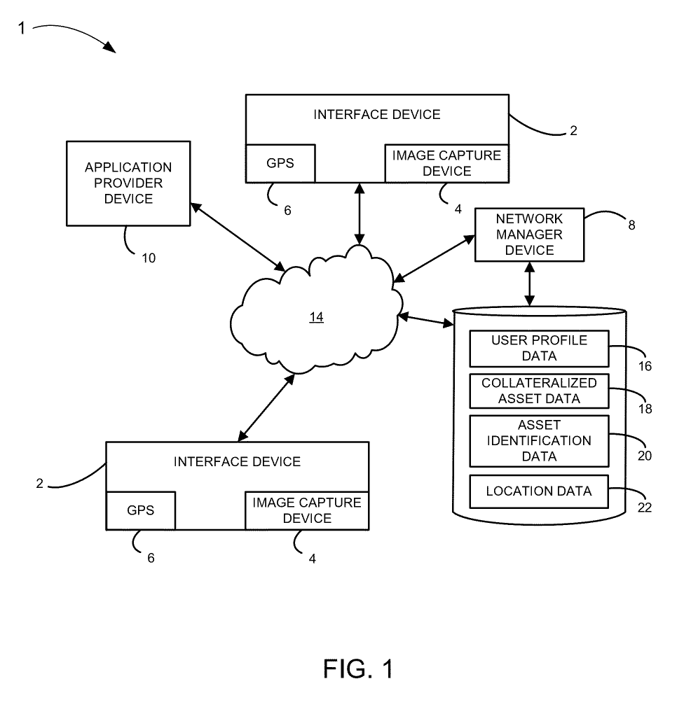

Referring now to FIG. 1, a block diagram depicts the details of a web-based system 1 for identifying, locating and recovering collateralized assets, in accordance with an embodiment of the instant invention. The system 1 includes multiple interface devices 2, each having an image capture device 4 and a GPS device 6, a network manager device 8, one or more application provider devices 10 and a database 12.

The interface devices 2, the network manager device 8, the application provider device 10 and the database 12 are communicatively connected through a network 14. The network 14 can include, by way of example, Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. The network 14 may also include optical communications. Other conventional and/or later developed wired and wireless networks may also be used.

The image capture device 4 can be separate from the interface device 2 or can be integral with the interface device 2. The image capture device 4 captures images and provides access to the images to the interface device 2. Images, as used herein, is intended to mean pictures and/or video content.

The interface device 2 is a user interface for a user that preferably provides a graphic user interface for the user to control the capturing of images as well as sending and receiving images via the network 14.

The interface device 2 sends and receives images via the network 12. The network manager device 8 hosts various processing and website hosting capabilities. The interface device 2 can download an application that provides the graphical user interface for capturing and sending images as well as communication with the network manager device 8. The interface device 2 can download the application from the network manager device 8 and/or the application provider device 10.

Examples of the interface device 2 include an IPHONE device by Apple, Inc., a mobile electronic device powered by ANDROID by Google, Inc. and a BLACKBERRY device by Research In Motion Limited. Other types of mobile electronic devices may be used, such as an ALPR camera.

In some embodiments, a mobile application may be downloaded, installed, and launched on the interface device 2 to enable the user to receive, send and display messaging, and forward images. The mobile application may take advantage of hardware and/or software functionality provided by manufacturers of the interface 2 device. For example, the mobile application may use the SAFARI web browser on the IPHONE device, the webkit browser on an ANDROID device, MOBILE INTERNET EXPLORER on a WINDOWS MOBILE device. The mobile application may use imaging or messaging functionality on any of the aforementioned devices. The mobile application may include instructions that when executed on the interface device 2 cause a machine to change its state or perform tasks within the machine and with other machines.

The mobile application may be downloaded from the application provider device 10 or from the network manager device 8. In general, the application provider device 10 is operated by an application provider that makes available mobile applications created by the application provider and/or third parties (e.g., the network manager) for download and use on mobile electronic devices. Examples of application providers include Apple, Inc. through its operation of ITUNES STORE, Google, Inc. through its operation of ANDROID MARKET, AT&T through its operation of its APPCENTER, and Research In Motion Limited through its operation of BLACKBERRY APP WORLD.

The network manager device 8 is in communication directly (e.g., through local storage) and/or through the network 14 (e.g., in a cloud configuration or software as a service) with the database 12. The database 12 may store user profile data 16, collateralized asset data 18, asset identification data 20 and location data 22.

The user profile data 16 includes information on users, such as username and passwords, addresses, phone numbers, email addresses, etc. The collateralized asset data 18 may include recovery requests and information on the collateralized assets that have been requested for recovery. VIN numbers, license plate numbers, addresses, etc of the collateralized assets may be stored in the collateralized asset data 18. The asset identification data 20 includes information on assets reported to the network manager device 8. The asset identification data 20 may include stored images sent by interface devices 2, identifying characteristics of the assets, time of sighting, etc. The assets may or may not be collateralized assets. The location data 22 includes location information on assets sent by the interface device 2. The location data 22 may include GPS data, such as coordinates, addresses, nearby landmarks, etc.

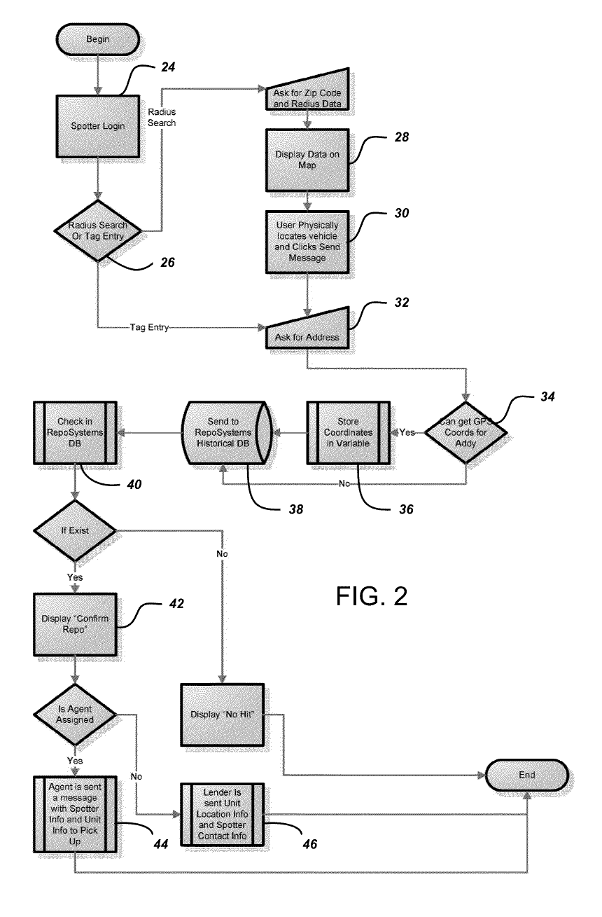

In the embodiment of FIG. 2, the user or an asset spotter, who may be either a professional recovery agent or a member of the general public, may log in via the interface device 2 connected to the network 14 to a designated web site hosted by the network manager device 8 to access the database 12 populated with information related to specific asset recovery requests furnished by lender subscribers (block 24). Access may be selectively on a no-cost or on a fee or periodic subscription basis, depending upon the classification of the asset spotter. After logging in, the user or asset spotter may enter either a search area radius, typically so many miles from his or her physical location (e.g. zip code), or, alternatively, if an asset has been tentatively identified, identifying information such as a license plate or VIN (block 26). In the former instance, the system responds with a map of the area requested containing pin-pointed suspected locations of assets subject to repossession orders that are believed to be within the specific area (block 28). The spotter uses this information to search for assets and once an asset is physically located (block 30), the identifying information or tag entry is transmitted electronically to the network manager device 8, which requests confirmation of the asset location address (blocks 32 and 34). Identifying information includes VIN, license plate number, vessel registration number and aircraft registration number. The asset location address may be stored in a variable storage location or in the location data 22 in the database 12 for future reference. The network manager device 8 may compare received asset data with the collateral asset data 18 (block 40). The network manager device 8 confirms that a repossession order exists for the asset with a confirmation message sent to the interface device 2 (block 42).

Upon confirmation, a repossession agent is notified with asset identifying and locating information (block 44) or the asset identifying and locating information is sent to the lender directly (block 46). The network manager device 8 may connect the asset spotter with the agent and/or the lender by providing a communication line via the network 14. Alternatively, the network manager device 8 may connect by passing contact information (e.g. email, phone number) between the asset spotter and the agent and/or lender. If the asset is not the subject of a repossession order, a “No Hit” message is returned to the spotter's interface device 2 (block 48), who may then initiate a search for another asset shown on the map. The information on the asset may be stored in the asset identification data 20 (block 38). Upon successful repossession of an identified and located collateralized asset, the network manager device 8 determines a payment of a finder's fee to the spotter and assesses a recovery fee to the lender. The recovery fee is greater than the finder's fee. The network manager device 8 can administer payment to the asset spotter and/or the lender.

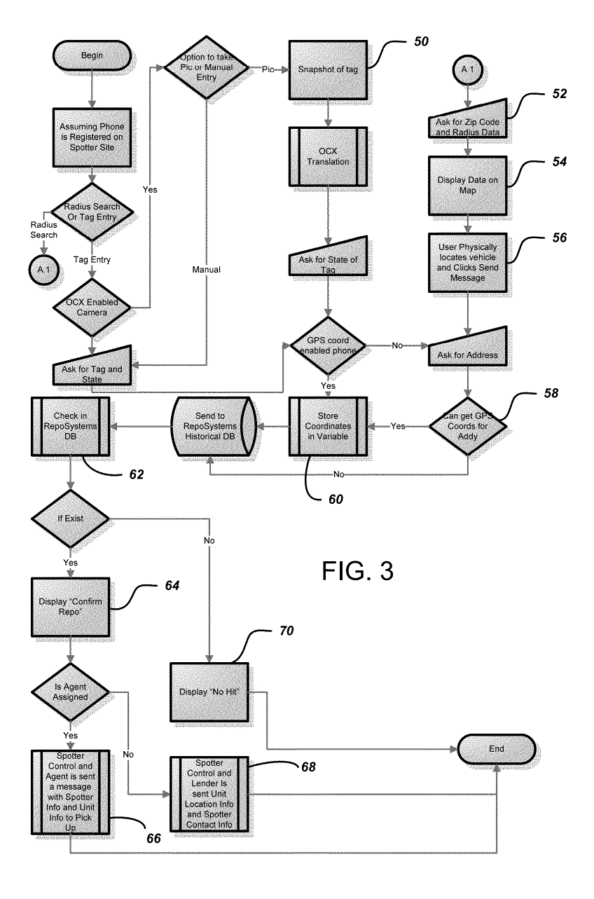

Referring to FIG. 3, in another embodiment of the instant invention, a method is provided which permits a user or spotter equipped with a GPS enabled interface device 2 to submit from the field asset data gathered in the field to the network manager device 8 for confirmation of the existence of a repossession order covering a specific asset. By way of example and not of limitation, an industrious asset spotter may canvass residential urban streets, parking lots of sports stadiums, shopping malls or large department stores and transmit images of thousands of license plate and/or VIN numbers to the network manager device 8 for verification (block 50).

As in the embodiment of FIG. 1, after logging in to the system, the user may enter either a search area radius, typically so many miles from his or her physical location (block 52). The system 1 responds with a map of the area requested containing pin-pointed suspected locations of assets subject to repossession orders that are believed to be within the specific area (block 54), as hereinabove described. The spotter uses this information to search for assets and once an asset is physically located, the identifying information or tag entry is transmitted electronically to the system (block 56). The GPS enabled interface device 2 may send GPS coordinates with the image (block 58). The GPS coordinates may be stored in a variable storage location or in the location data 22 of the database 12 for future reference (block 60). The network manager device 8 may compare received asset data with the collateral asset data 18 (block 62). The network manager device 8 then confirms that a repossession order exists for the asset with a confirmation message sent to the interface device 2 (block 64).

Upon confirmation, a repossession agent is notified with asset identifying and locating information (block 66) or the asset identifying and locating information is sent to the lender directly (block 68). The network manager device 8 may connect the asset spotter with the agent and/or the lender by providing a communication line via the network 14. Alternatively, the network manager device 8 may connect by passing contact information (e.g. email, phone number) between the asset spotter and the agent and/or lender. If the asset is not the subject of a repossession order, a “No Hit” message is returned to the spotter's interface device 2 (block 70), who may then initiate a search for another asset shown on the map. The information on the asset is stored in the asset identification data 20. Upon successful repossession of an identified and located collateralized asset, the network manager device 8 determines a payment of a finder's fee to the spotter and assesses a recovery fee to the lender. The recovery fee is greater than the finder's fee. The network manager device 8 can administer payment to the asset spotter and/or the lender.

A unique aspect of the invention is the fact that members of the general public may function as spotters who are simply paid a finder's fee upon a successful asset recovery. The system provider incurs little or no overhead costs related to having these asset spotters in the field, thus not only enormously enhancing the profitability of the enterprise, but also significantly reducing costs and inefficiencies typically associated with prior art recovery processes.

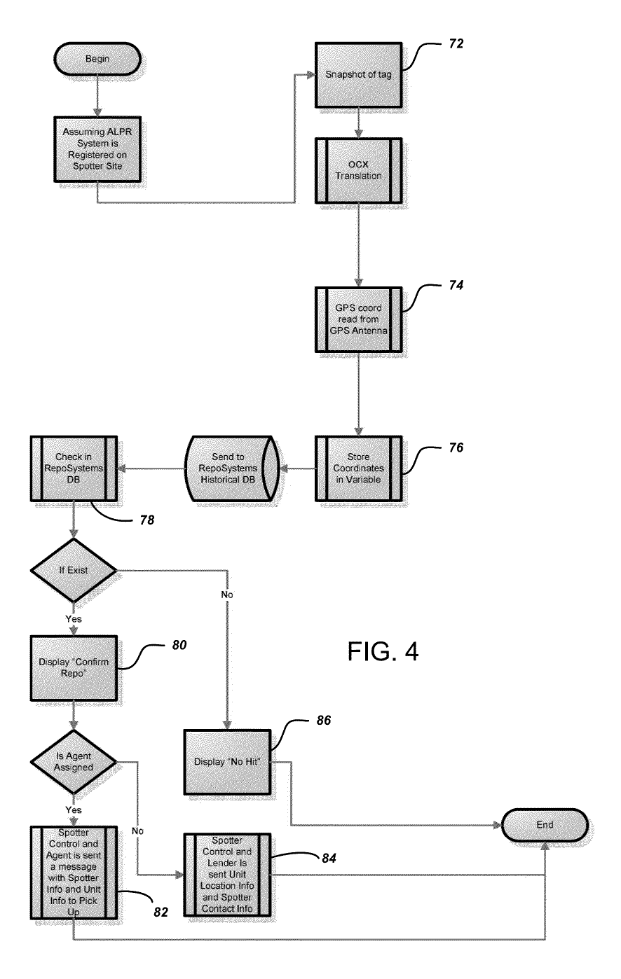

Referring now to FIG. 4, in accordance with yet another embodiment of the present invention, a method is provided which enables an individual user or asset spotter in the field equipped with an ALPR camera to access the network manager device 8 to upload images of vehicular license plates, VINs or other identifying characteristics with GPS location coordinates (block 74) virtually instantaneously as the images are captured. The GPS coordinates may be stored in a variable storage location or in the location data 22 of the database 12 for future reference (block 76). The network manager device 8 may compare received asset data with the collateral asset data 18 (block 78). The network manager device 8 then confirms that a repossession order exists for the asset with a confirmation message sent to the interface device 2 (block 80).

Upon confirmation, a repossession agent is notified with asset identifying and locating information (block 82) or the asset identifying and locating information is sent to the lender directly (block 84). The network manager device 8 may connect the asset spotter with the agent and/or the lender by providing a communication line via the network 14. Alternatively, the network manager device 8 may connect by passing contact information (e.g. email, phone number) between the asset spotter and the agent and/or lender. If the asset is not the subject of a repossession order, a “No Hit” message is returned to the spotter's interface device 2 (block 86), who may then initiate a search for another asset shown on the map. The information on the asset is stored in the asset identification data 20. Upon successful repossession of an identified and located collateralized asset, the network manager device 8 determines a payment of a finder's fee to the spotter and assesses a recovery fee to the lender. The recovery fee is greater than the finder's fee. The network manager device 8 can administer payment to the asset spotter and/or the lender.

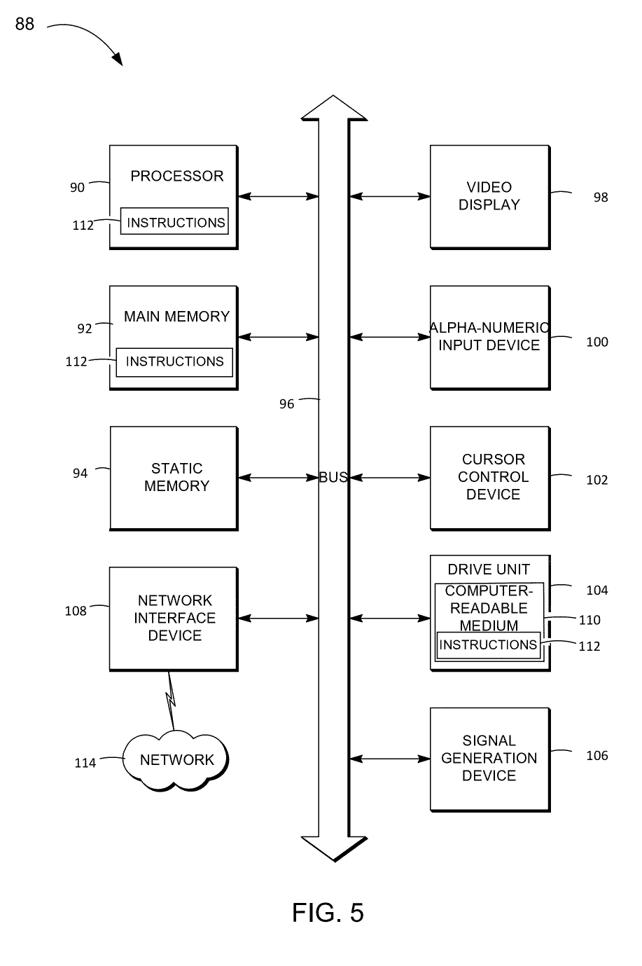

FIG. 5 shows a block diagram of a machine in the example form of a computer system 88 within which a set of instructions may be executed causing the machine to perform any one or more of the methods, processes, operations, or methodologies discussed herein. The interface device 2, the network manager device 8, and/or the application provider device 10 may include the functionality of one or more computer systems 88.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a gaming device, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 88 includes a processor 90 (e.g., a central processing unit (CPU) a graphics processing unit (GPU) or both), a main memory 92 and a static memory 94, which communicate with each other via a bus 96. The computer system 88 further includes a video display unit 98 (e.g., a liquid crystal display (LCD) or a cathode ray tube (CRT)). The computer system 88 also includes an alphanumeric input device 100 (e.g., a keyboard), a cursor control device 102 (e.g., a mouse), a drive unit 104, a signal generation device 106 (e.g., a speaker) and a network interface device 108.

The drive unit 104 includes a computer-readable medium 110 on which is stored one or more sets of instructions (e.g., software 112) embodying any one or more of the methodologies or functions described herein. The software 112 may also reside, completely or at least partially, within the main memory 92 and/or within the processor 90 during execution thereof by the computer system 88, the main memory 92 and the processor 90 also constituting computer-readable media.

The software 112 may further be transmitted or received over a network 114 via the network interface device 108.

While the computer-readable medium 110 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media. In some embodiments, the computer-readable medium is a non-transitory computer-readable medium.

In understanding the scope of the present invention, the term “configured” as used herein to describe a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, devices, and/or steps, but do not exclude the presence of other unstated features, elements, components, groups, devices and/or steps. The foregoing also applies to words having similar meanings such as the terms, “including”, “having” and their derivatives. Also, singular terms can have the dual meaning of a single part or a plurality of parts.

Changes may be made in the above methods and systems without departing from the scope hereof. It should thus be noted that the matter contained in the above description and/or shown in the accompanying figures should be interpreted as illustrative and not in a limiting sense. The following claims are intended to cover all generic and specific features described herein, as well as all statements of the scope of the present systems and methods, which, as a matter of language, might be said to fall there between.

What is claimed is:

1. A method for identifying, locating and recovering collateralized assets comprising:
populating a database with collateralized asset data extracted from collateralized asset recovery requests;
generating identification and location data on collateralized assets which are the subject of at least one of the recovery requests;
accessing the database remotely;
receiving asset identification and location data generated by an asset spotter;
comparing, on a processor, the collateralized asset identification and location data with collateralized asset data;
sending confirmation that the collateralized asset identification and location data is subject to at least one collateralized asset recovery request; and
initiating a collateralized asset recovery procedure.

2. The method of claim 1 wherein the accessing includes remotely logging in to a designated Internet website to access the database.

3. The method of claim 1 wherein the accessing includes remotely logging in to a designated Internet website with a wireless telecommunication device.

4. The method of claim 3, wherein the wireless telecommunication device includes a cellular telephone.

5. The method of claim 3, wherein the wireless telecommunication device includes an iPad.

6. The method of claim 1, further comprising storing the collateralized asset identification and location data collected by the asset spotter for future reference.

7. The method of claim 1, further comprising determining, on a processor, a finder's fee to the asset spotter upon successful repossession of an identified and located collateralized asset.

8. The method of claim 7, further comprising assessing, on a processor, a recovery fee to a lender upon successful repossession of an identified and located collateralized asset.

9. The method of claim 1, wherein the collateralized asset identification and location data includes GPS location coordinates.

10. The method of claim 1, further comprising accessing the computerized system with a data stream of collateralized asset identification data via an automatic license plate recognition camera.

11. The method of claim 1, wherein the initiating includes connecting the asset spotter to a recovery agent or lender seeking to recover the collateralized asset.

12. The method of claim 1, wherein the accessing includes searching the database for a collateralized asset based on vehicle identification number.

13. The method of claim 1, wherein the accessing includes searching the database for a collateralized asset based on a license plate number.

14. The method of claim 1, wherein the accessing includes searching the database for a collateralized asset based on a vessel registration number.

15. The method of claim 1, wherein the accessing includes searching the database for a collateralized asset based on an aircraft registration number.

16. The method of claim 1, wherein the accessing includes searching the database for a collateralized asset by way of a radius search based on a designated geographic location.

17. A system for identifying, locating and recovering collateralized assets comprising:
a database populated with collateralized asset data extracted from collateralized asset recovery requests;
an interface device configured to generate identification and location data on collateralized assets which are the subject of at least one of the recovery requests, the interface device being further configured to access the database remotely; and
a network manager device for receiving asset identification and location data generated by the interface device, the network manager device being configured to compare, on a processor, the collateralized asset identification and location data with collateralized asset data and to send confirmation that the collateralized asset identification and location data is subject to at least one collateralized asset recovery request to the interface device.

18. The system of claim 17, further comprising an application provider device for connection with the interface device.

19. The system of claim 17, wherein the interface device accesses the database by remotely logging in to a designated Internet website hosted by the network manager device.

20. The system of claim 17, wherein the interface device includes a wireless telecommunication device.

21. The system of claim 20, wherein the wireless telecommunication device includes a cellular telephone.

22. The system of claim 20, wherein the wireless telecommunication device includes an iPad.

23. The system of claim 17, wherein the network manager device is further configured to determine a finder's fee to the asset spotter upon successful repossession of an identified and located collateralized asset.

24. The system of claim 23, wherein the network manager device is further configured to assess a recovery fee to a lender upon successful repossession of an identified and located collateralized asset.

25. The system of claim 17, wherein the collateralized asset identification and location data includes GPS location coordinates.

26. The system of claim 17, wherein the interface device includes an automatic license plate recognition camera.

27. A method for identifying, locating and recovering collateralized assets comprising:
populating a database with collateralized asset data extracted from collateralized asset recovery requests;
receiving asset identifying information on an asset generated by an asset spotter, the asset identifying information being one or more of vehicle identification number, license plate number, vessel registration number and aircraft registration number;
comparing, on a processor, the identifying information with collateralized asset data; and
sending confirmation that the asset is subject to a collateralized asset recovery request.
